(19) United States
(12) Patent Application Publication
(10) Pub. No.: US 2026/0366959 A1
(43) Pub. Date: Nov. 19, 2026

(54) METHOD AND DEVICE FOR MEASURING NONLINEAR COEFFICIENT OF OPTICAL FIBER

(71) Applicant: NTT, Inc., Tokyo (JP)

(72) Inventors: Taiji SAKAMOTO, Musashino-shi, Tokyo (JP); Kazuhide NAKAJIMA, Musashino-shi, Tokyo (JP); Ryota IMADA, Musashino-shi, Tokyo (JP)

(73) Assignee: NTT, Inc., Tokyo (JP)

(21) Appl. No.: 19/136,403

(22) PCT Filed: Oct. 31, 2023
(86) PCT No.: PCT/JP2023/039322

§ 371 Date: Jun. 6, 2025

(30) Foreign Application Priority Data
Dec. 20, 2022 (WO) PCT/JP2022/046908

(51) Int. Cl. G01M 11/00

(52) U.S. Cl. CPC G01M 11/335

(57) ABSTRACT

An optical fiber nonlinear coefficient measurement device measures a nonlinear coefficient of an optical fiber. The device includes: a transmitter including two light sources, that each emit a ray of continuous wave light and an optical coupler to combine two rays of continuous wave light supplied from the two light sources, configured to set an interval between wavelengths of the two rays to be equal to or less than a value calculated by using an average value of the wavelengths of the two rays of continuous wave light, a length of the optical fiber, which is a measurement target, and a spatial mode dispersion coefficient of the optical fiber; and a receiver including an optical spectrum analyzer, having a resolution at which an interval between the wavelengths is detected, configured to measure a spectrum of propagation light from the optical fiber.

### TECHNICAL FIELD

The present disclosure relates to a method and device for measuring the nonlinear coefficient of an optical fiber.

### BACKGROUND ART

In an optical fiber communication system, transmission capacity is limited by a nonlinear effect and a fiber fuse generated in an optical fiber. In order to alleviate these limitations, spatial multiplexing techniques such as parallel transmission using a multicore fiber (MCF) having a plurality of cores in one optical fiber, and mode multiplexing transmission using a multi-mode fiber in which a plurality of propagation modes exist in a core have been studied (Non Patent Literatures 1 to 3).

In transmission using a multicore fiber or a multi-mode fiber, signal quality deteriorates when crosstalk between cores occurs, and thus it is necessary to separate the cores from each other by a certain amount or more in order to control the crosstalk. In general, in order to ensure sufficient transmission quality in an optical communication system, it is desirable to set the power penalty to 1 dB or less, and for this purpose, the crosstalk needs to be set to-26 dB or less as disclosed in Non Patent Literature 1 or 4.

On the other hand, when the MIMO technology is used, it is possible to compensate for crosstalk at a reception end, and it is possible to reduce an inter-core distance, to make the power penalty less than 1 dB through signal processing even if the crosstalk is-26 dB or more, and to improve the space utilization efficiency. However, in a case where the MIMO technology is applied, when a group delay spread (GDS) caused by a differential modal group delay (DMD) between a plurality of rays of signal light generated in a transmission path is large, an impulse response width of the transmission path increases, leading to an increase in signal processing.

In a single-mode multicore fiber having a structure in which a structure of each core propagates a single mode, as disclosed in Non Patent Literature 5, a coupled multicore fiber in which a core structure and a core interval are adjusted such that random coupling between modes is induced has been studied. The coupled multicore fiber has a special characteristic that the group delay spread is proportional to the square root of a distance, and the group delay spread is controlled even in long distance transmission as compared with a few-mode fiber or the like. Therefore, the coupled multicore fiber is expected to be an optical fiber capable of reducing MIMO signal processing. In general, an inter-core distance of the coupled multicore fiber is mostly in the range of 15 to 25 μm. However, in a case where core structure is greatly different from that of the conventional single-mode fiber, it is conceivable that the core structure exceeds this range. In general, it can be said that a multicore fiber designed to have an inter-core crosstalk of-10 dB/km or more when calculated is a coupled multicore fiber.

From the viewpoint that the group delay spread is proportional to the square root of a distance, it can be said that a phenomenon similar to the polarization mode dispersion also occurs with respect to a dispersion between modes in the coupled multicore fiber, and a performance index called a spatial mode dispersion (SMD) coefficient is defined in Non Patent Literature 5 for the coupled multicore fiber. This definition is applied to only an optical fiber in which modes are sufficiently randomly coupled, and for example, in a multi-mode fiber or the like, a mode dispersion is proportional to a distance, and the mode dispersion is defined as an inter-mode differential modal group delay (Non Patent Literature 2).

In the coupled multicore fiber, it can be expected that an optical fiber non-linearity phenomenon will be controlled as compared with a non-coupled multicore fiber in addition to the low group delay spread, and low non-linearity of the coupled multicore fiber has been confirmed in a transmission experiment (Non Patent Literature 6). In addition, also in theoretical studies, studies on the assumption of a few-mode fiber have been conducted, and it has been disclosed that the fiber has low nonlinearity (Non Patent Literature 7).

### CITATION LIST

### Non Patent Literature

Non Patent Literature 1: H. Takara et al., “1.01-Pb/s (12 SDM/222 WDM/456 Gb/s) Crosstalk-managed Transmission with 91.4-b/s/Hz Aggregate Spectral Efficiency,” in ECOC2012, paper Th. 3.C.1 (2012)
Non Patent Literature 2: T. Sakamoto et al., “Differential Mode Delay Managed Transmission Line for WDM-MIMO System Using Multi-Step Index Fiber,” J. Lightwave Technol. vol. 30, pp. 2783-2787 (2012).
Non Patent Literature 3: Y. Sasaki et al., “Large-effective-area uncoupled few-mode multi-core fiber,” ECOC2012, paper Tu.1.F.3 (2012).
Non Patent Literature 4: T. Ohara et al., “Over-1000-Channel Ultradense WDM TransmissionWith Supercontinuum Multicarrier Source,” IEEE J. Lightw. Technol., vol. 24, pp. 2311-2317 (2006)
Non Patent Literature 5: T. Sakamoto, T. Mori, M. Wada, T. Yamamoto, F. Yamamoto, and K. Nakajima, “Fiber Twisting- and Bending-Induced Adiabatic/Nonadiabatic Super-Mode Transition in Coupled Multicore Fiber,” J. Lightwave Technol. 34, 1228-1237 (2016).
Non Patent Literature 6: R. Ryf et al., “Long-Haul Transmission over Multi-Core Fibers with Coupled Cores,” in Proc. of ECOC2017, M.2.E.1 (2017).
Non Patent Literature 7: S. Mumtaz et al., “Nonlinear Propagation in Multimode and Multicore Fibers: Generalization of the Manakov Equations,” J. Lightw. Technol., 31, 398-406, (2013).

### SUMMARY OF INVENTION

### Technical Problem

However, a technique for measuring a nonlinear coefficient of a coupled multicore fiber or a multi-mode fiber is not provided, and a nonlinear coefficient of an optical fiber that is a manufactured coupled multicore fiber or multi-mode fiber cannot be measured.

The present disclosure is proposed in view of the above circumstances, and an object thereof is to provide an optical fiber nonlinear coefficient measurement method and device capable of measuring a nonlinear coefficient of an optical fiber that is a coupled multicore fiber or a multi-mode fiber.

### Solution to Problem

In order to solve the above-described problem, an optical fiber nonlinear coefficient measurement method is a method for measuring a nonlinear coefficient of an optical fiber that is a coupled multicore fiber or a multi-mode fiber, the method including: a step of setting an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and causing incident light obtained by combining the two rays of continuous wave light to be incident on the optical fiber; a step of measuring a spectrum of propagation light from the optical fiber; and a step of calculating a nonlinear coefficient on the basis of the measured spectrum.

An optical fiber nonlinear coefficient measurement device is a device measuring a nonlinear coefficient of an optical fiber that is a coupled multicore fiber or a multi-mode fiber, the device including: a transmission unit that: includes two light sources each configured to emit a ray of continuous wave light and an optical coupler configured to combine two rays of continuous wave light supplied from the two light sources; and configured to set an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and causes incident light obtained by combining the two rays of continuous wave light to be incident on the optical fiber; and a reception unit that includes an optical spectrum analyzer: having a resolution at which an interval between the wavelengths is able to be detected; and configured to measure a spectrum of propagation light from the optical fiber.

### Advantageous Effects of Invention

According to the present disclosure, it is possible to measure a nonlinear coefficient of an optical fiber that is a coupled multicore fiber or a multi-mode fiber.

### BRIEF DESCRIPTION OF DRAWINGS

FIG. 1 is a block diagram illustrating a schematic configuration of an optical fiber nonlinear coefficient measurement device according to a first embodiment.

FIG. 2 is a flowchart illustrating a series of steps of an optical fiber nonlinear coefficient measurement method according to the first embodiment.

FIG. 3 is a diagram illustrating a spectrum of propagation light from an optical fiber.

FIG. 4 is a graph illustrating a relationship between a wavelength interval Δλ and a light intensity ratio I₁/I₂.

FIG. 5 is a graph illustrating a relationship between incident power and a nonlinear phase rotation amount φₘₐₓ.

FIG. 6 is a graph illustrating a relationship between a nonlinear coefficient γ_{eff} based on measurement and a nonlinear coefficient γ_{eff} based on theory.

FIG. 7 is a block diagram illustrating a configuration of a measurement device of a comparative example.

FIG. 8 is a graph illustrating a spectrum of a single-mode fiber measured using the measurement device of the comparative example.

FIG. 9 is a graph illustrating a relationship between incident power and the nonlinear phase rotation amount φₘₐₓ in a single-mode fiber measured using the measurement device of the comparative example.

FIG. 10 is a graph illustrating a spectrum of a coupled multicore fiber measured using the measurement device of the comparative example.

FIG. 11 is a graph obtained by measuring a transmission loss of the coupled multicore fiber.

FIG. 12 is a block diagram illustrating a schematic configuration of an optical fiber nonlinear coefficient measurement device according to a second embodiment.

FIG. 13 is a flowchart illustrating a series of steps of an optical fiber nonlinear coefficient measurement method according to the second embodiment.

FIG. 14 is a diagram illustrating a spectrum of propagation light from an optical fiber.

FIG. 15 is a graph illustrating a relationship between a wavelength interval Δλ and a ratio I₁/I₂ of light intensities.

FIG. 16 is a graph illustrating a relationship between incident power and the nonlinear phase rotation amount φₘₐₓ.

FIG. 17 is a graph illustrating a relationship between a nonlinear coefficient γ_{eff} based on measurement and a nonlinear coefficient γ_{eff} based on theory.

FIG. 18 is a graph illustrating a relationship between a wavelength interval Δλ and a light intensity ratio I₁/I₂ for fourth samples having different lengths.

FIG. 19 is a graph illustrating a relationship between a total spatial dispersion and a wavelength interval Δλmax.

FIG. 20 is a block diagram illustrating a configuration of a measurement device of a comparative example.

FIG. 21 is a graph illustrating a spectrum of a single-mode fiber measured using a measurement device of a comparative example.

FIG. 22 is a graph illustrating a relationship between incident power and the nonlinear phase rotation amount φₘₐₓ in a single-mode fiber measured using the measurement device of the comparative example.

FIG. 23 is a graph illustrating a spectrum of a coupled multicore fiber measured using the measurement device of the comparative example.

FIG. 24 is a graph obtained by measuring a transmission loss of the coupled multicore fiber.

### DESCRIPTION OF EMBODIMENTS

### First Embodiment

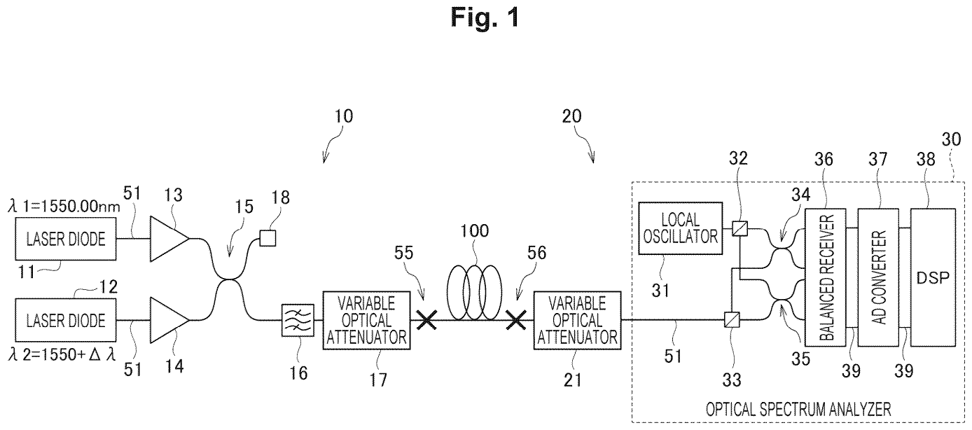

An optical fiber nonlinear coefficient measurement method and device according to a first embodiment will be described. The first embodiment relates to a coupled multicore fiber. FIG. 1 is a block diagram illustrating a schematic configuration of a measurement device of the first embodiment. As illustrated in FIG. 1, the measurement device includes a transmission unit 10 that transmits light incident on an optical fiber 100 that is a measurement target, and a reception unit 20 that receives propagation light from the optical fiber 100.

The transmission unit 10 includes a first laser diode (LD) 11 that emits a first wavelength λ₁ of 1550 nm of continuous wave (CW) light as a first light source, and a second laser diode 12 that emits a second wavelength λ₂ of 1550+Δλ nm of continuous wave light as a second light source. The transmission unit 10 sets an interval AA between the wavelengths λ₁ and λ₂ of the two rays of continuous wave light to be equal to or less than a value calculated by using an average value λ of the wavelengths λ₁ and λ₂ of the two rays of continuous wave light, a length L of the optical fiber 100, which is a measurement target, and a spatial mode dispersion coefficient k of the optical fiber. Specifically, the interval Δλ between the first wavelength λ₁ and the second wavelength λ₂ is defined by Expression (1).

$$\begin{matrix}[ Math . 1 ] & \\ Δ λ \leq 0.177 \frac{{λ}^{2}}{c k \sqrt{L}} & ( 1 )\end{matrix}$$

In Expression (1), the wavelength λ is an average value (m) of the first wavelength λ₁ and the second wavelength λ₂, c is the speed of light (m) in a vacuum, k is a spatial mode dispersion coefficient k (s/√km), and L is a length (km) of the optical fiber 100, which is a measurement target.

Here, the spatial mode dispersion coefficient k is defined as a value obtained by performing Fourier transform on the frequency-to-transmission loss spectrum of the coupled multicore fiber such that a waveform having an obtained time delay as a horizontal axis is a Gaussian waveform, and dividing a standard deviation thereof by the square root of the length L of the optical fiber 100. Therefore, when a variation cycle Δf of a transmission loss spectrum corresponds to a time delay difference in a case where the length of the optical fiber 100 is L, the variation cycle Δf has a relationship of Expression (2).

$$\begin{matrix}[ Math . 2 ] & \\ Δ f ∝ \frac{1}{k \sqrt{L}} & ( 2 )\end{matrix}$$

The variation cycle Δf and the wavelength interval Δλ have a relationship of the following Expression (3).

$$\begin{matrix}[ Math . 3 ] & \\ Δ f = \frac{c ( {λ}_{1} - {λ}_{2} )}{{λ}_{1} {λ}_{2}} \approx \frac{c Δ λ}{{λ}^{2}} & ( 3 )\end{matrix}$$

For example, since the spatial mode dispersion coefficient k of the two-core optical fiber 100 having a length of 500 m is 40 ps/√km and the condition of the wavelength interval Δλ is 0.05 nm or less, it is empirically considered that Expression (4) is satisfied by using a correction coefficient A.

$$\begin{matrix}[ Math . 4 ] & \\ \frac{c 0.05 \times 1 {0}^{- 9}}{{λ}^{2}} \leq \frac{A}{40 \times 1 {0}^{- 12} \sqrt{0.5}} & ( 4 )\end{matrix}$$

When the correction coefficient A is calculated from Expression (4), Expression (5) is obtained. Expression (1) is obtained on the basis of Expression (5).

$$\begin{matrix}[ Math . 5 ] & \\ A \geq 0.177 & ( 5 )\end{matrix}$$

In the transmission unit 10, a first optical amplifier 13 and a second optical amplifier 14 are respectively connected to subsequent stages of the first laser diode 11 and the second laser diode 12 via optical paths 51. Each of the first optical amplifier 13 and the second optical amplifier 14 may be a polarization maintaining type (PM) Er-doped optical fiber amplifier (EDFA). An optical coupler 15 is connected to subsequent stages of the first optical amplifier 13 and the second optical amplifier 14, and the optical paths 51 from the first optical amplifier 13 and the second optical amplifier 14 are integrated by the optical coupler 15 and then branched into two optical paths 51 again. The optical coupler 15 may include an optical fiber coupler. One of the optical paths 51 branched from the optical coupler 15 reaches one end of the optical fiber 100 at a first connection portion 55 via a band-pass filter (BPS) 16 and a first variable optical attenuator 17. The other of optical paths 51 branched from the optical coupler 15 is connected to an optical terminator 18.

The reception unit 20 includes a second variable optical attenuator 21 and an optical spectrum analyzer 30. The optical spectrum analyzer 30 has a high resolution such that the interval Δλ between the first wavelength λ₁ and the second wavelength λ₂ can be detected. The second variable optical attenuator 21 is connected to the other end of the optical fiber 100 at a second connection portion 56.

The optical spectrum analyzer 30 includes a local oscillator (LO) 31, a first polarization beam splitter (PBS) 32 connected to the local oscillator 31, and a second polarization beam splitter 33 connected to the second variable optical attenuator 21. The polarized light split by the first polarization beam splitter 32 and the second polarization beam splitter (PBS) 33 is incident on a balanced receiver 36 via a second optical coupler 34 and a third optical coupler 35, and is converted into an electrical signal through photoelectric conversion. The signal output from the balanced receiver 36 is subject to analog-to-digital conversion by an AD converter 37, and predetermined computation is performed by a digital signal processor (DSP) 38 such that a nonlinear coefficient of the optical fiber 100 is calculated. The computation in the digital signal processor 38 will be described later. The balanced receiver 36, the AD converter 37, and the digital signal processor 38 are connected via a suitable line 39.

In the first embodiment, a coupled multicore fiber in which crosstalk occurs between adjacent cores is assumed as the optical fiber 100, which is a measurement target. However, the present invention is not limited thereto, and may be applied to a single-mode fiber in which each core propagates a single mode. The optical fiber 100 is connected to the optical path 51 at each of the first connection portion 55 of the transmission unit 10 and the second connection portion 56 of the reception unit 20. The connection at the first connection portion 55 and the second connection portion 56 may be performed by using an optical connector, or may be performed by fusing the optical fiber 100 to the optical path 51.

The measurement device of the first embodiment having such a configuration has a feature that the wavelength interval Δλ between the first wavelength λ₁ of the first laser diode 11 and the second wavelength λ₂ of the second laser diode 12 included in the transmission unit 10 is small, for example, 0.1 nm or less. Corresponding to the transmission unit 10, the optical spectrum analyzer 30 included in the reception unit 20 causes propagation light from the optical fiber 100 to interfere with local light oscillated in the local oscillator 31, receives the light in the balanced receiver 36, and then performs signal processing in the electrical domain in the digital signal processor 38 via the AD converter 37, thereby realizing a resolution of 0.1 μm or less.

In the first embodiment, the local oscillator 31 is implemented by individual laser diodes, and a frequency difference or a phase difference between the propagation light and the local light are compensated through signal processing. Light obtained by partially branching the propagation light from the transmission unit 10 may be used as the local light. In this case, a frequency difference can be made substantially 0, so that a signal processing portion can be simplified. As described above, in the first embodiment, the optical spectrum analysis based on the above method is essential, and the configuration is largely different from that of the conventional measurement device.

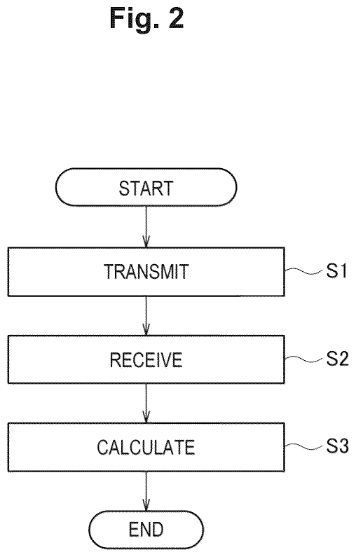

FIG. 2 is a flowchart illustrating a series of steps of the measurement method of the first embodiment. The measurement method of the first embodiment is performed in the measurement device of the first embodiment illustrated in FIG. 1. Hereinafter, a series of steps of the measurement method of the first embodiment will be described in order.

In step S1, light is transmitted from the transmission unit 10 of the measurement device and made incident on the optical fiber 100. In the transmission unit 10, the first laser diode 11 emits continuous wave light having the first wavelength λ₁ of 1550 nm, and the second laser diode 12 of the second light source emits continuous wave light having the second wavelength λ₂ of 1550+Δλ nm. The interval Δλ between the first wavelength λ₁ and the second wavelength λ₂ is defined by Expression (1). The rays of single-wavelength light emitted from the first laser diode 11 and the second laser diode 12 have their optical power amplified by the first optical amplifier 13 and the second optical amplifier 14, and are then combined by the optical coupler 15 with their polarization state aligned, and become sinusoidal light with an envelope oscillating at a frequency corresponding to the wavelength difference. This light passes through the band-pass filter 16 and the first variable optical attenuator 17 and is incident on one end of the optical fiber 100, which is a measurement target. In the first variable optical attenuator 17, the light intensity is adjusted to a desired light intensity.

In step S2, the reception unit 20 of the measurement device receives the propagation light from the optical fiber 100. The propagation light from the optical fiber 100 is adjusted in its light intensity by the second variable optical attenuator 21, then is incident on the optical spectrum analyzer 30, and is split into polarized light by the second polarization beam splitter 33. The light is combined by the second optical coupler 34 and the third optical coupler 35 with the light emitted from the local oscillator 31 and split into the polarized light by the first polarization beam splitter 32, and is then incident on the balanced receiver 36. In the optical spectrum analyzer 30, the local light emitted from the local oscillator 31 interferes with the propagation light from the optical fiber 100 in the second optical coupler 34 and the third optical coupler 35 and is incident on the balanced receiver 36, thereby achieving a high resolution of, for example, a wavelength of 0.1 pm or less. The balanced receiver 36 photoelectrically converts the incident light into an electrical signal by using an appropriate light receiving element, such as a photodiode. The electrical signal obtained through photoelectric conversion in the balanced receiver 36 is subject to analog-to-digital conversion by the AD converter 37 and then sent to the digital signal processor 38.

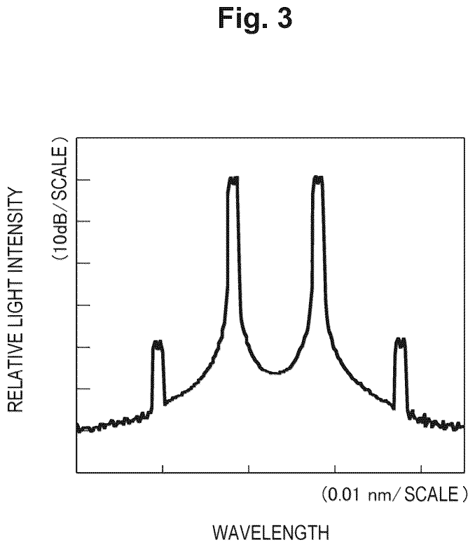

FIG. 3 is a graph illustrating a spectrum of propagation light from the optical fiber 100. As the optical fiber 100, a two-core coupled multicore fiber is used. The wavelength interval Δλ between the first wavelength λ₁ of the first laser diode 11 and the second wavelength λ₂ of the second laser diode 12 is 0.01 nm. The horizontal axis of the graph of FIG. 3 represents a wavelength, and the vertical axis represents a light intensity of the spectrum. In the graph, it is observed that sub-peaks due to self-phase modulation that is one of nonlinear phenomena occur on both sides of main peaks due to continuous wave light emitted from the first laser diode 11 and the second laser diode 12 near the center, depending on the light intensity. Here, the light intensity of the main peak is denoted by I₁, and the light intensity of the sub-peak is denoted by I₂.

In step S3, the digital signal processor 38 of the reception unit 20 of the measurement device performs computation to calculate a nonlinear coefficient of the optical fiber 100. In step S3, the computation is performed on the basis of the propagation light from the optical fiber 100 received in step S2.

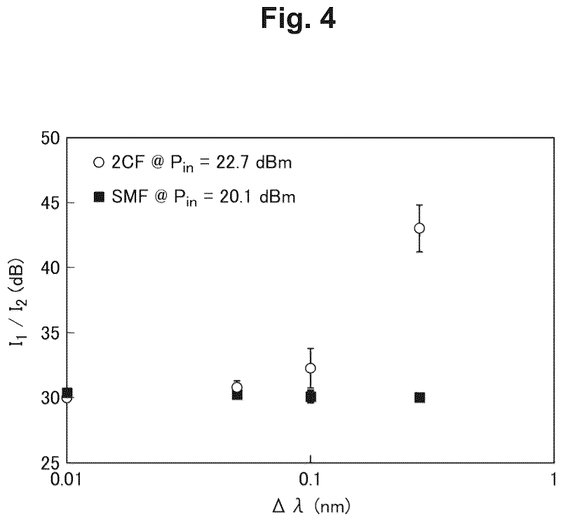

FIG. 4 is a graph illustrating a relationship between the wavelength interval Δλ and the light intensity ratio I₁/I₂. In the graph, data of a two-core coupled multicore fiber is illustrated. The measurement was performed 20 times, and the incident power was 22.7 dBm on average. Error bars indicate the maximum value and the minimum value of data that fluctuate in 20 measurements. FIG. 4 also illustrates measurement results for the single-mode fiber. The single-mode fiber was also measured 20 times, and the incident power was 20.1 dBm on average. Since the dependency of the light intensity ratio I₁/I₂ on the wavelength interval Δλ is derived from the nonlinear characteristics of the optical fiber 100, the result in the single-mode fiber shows a result that there is no dependency on the wavelength interval Δλ. In addition, in the single-mode fiber, it was observed that an amount of variation in 20 measurements was also extremely small.

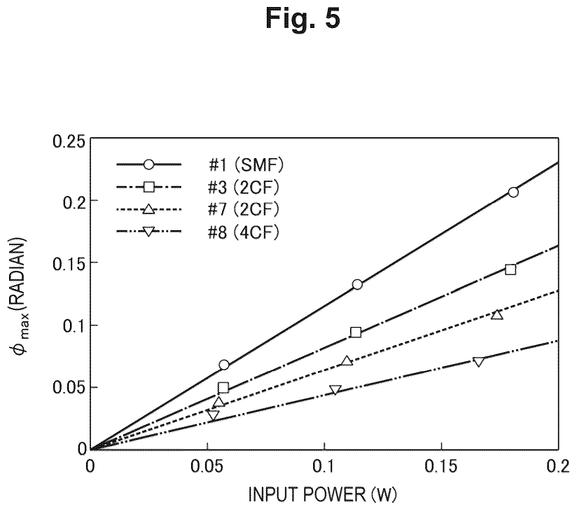

FIG. 5 is a graph illustrating a relationship between the incident power and the nonlinear phase rotation amount φₘₐₓ. Here, among the types of samples illustrated in Table 1, data obtained by measuring the first, third, seventh, and eighth samples as the optical fiber 100, which is a measurement target, is illustrated. The first sample is a single-mode fiber, the third and seventh samples are two-core coupled multicore fibers, and the eighth sample is a four-core coupled multicore fiber.

TABLE 1

| | | | | | SPECIFIC |
|---|---|---|---|---|---|
| | | | | | REFRACTIVE |
| | | | | CORE | INDEX |
| SAMPLE | NUMBER OF | CORE PITCH | | RADIUS | DIFFERENCE |
| NUMBER# | CORES | (μm) | DOPANT | (μm) | (%) |
| 1 | 1 | NA | GeO₂ CORE | 4.2 | 0.34 |
| 2 | 2 | 20 | GeO₂ CORE | 4.5 | 0.44 |
| 3 | 2 | 25 | GeO₂ CORE | 4.5 | 0.4 |
| 4 | 2 | 20 | F CLAD | 4.5 | 0.38 |
| 5 | 2 | 25 | F CLAD | 4.4 | 0.35 |
| 6 | 2 | 21 | F CLAD | 3.3 | 0.67 |
| 7 | 2 | 21 | F CLAD | 4.8 | 0.3 |
| 8 | 4 | 18 | F CLAD | 4.2 | 0.33 |

The nonlinear phase rotation amount φₘₐₓ was obtained from Expression (6) on the basis of the light intensity ratio I₁/I₂ for the light intensity I₁ of the main peak and the light intensity I₂ of the sub-peak in the spectrum of the propagation light from the optical fiber 100 as illustrated in FIG. 3. Here, Jx (where x=0, 1, and 2) is a first-type x-order Bessel function.

$$\begin{matrix}[ Math . 6 ] & \\ \frac{{I}_{1}}{{I}_{2}} = \frac{{J}_{0}^{2} ( {ϕ}_{max} / 2 ) + {J}_{1}^{2} ( {ϕ}_{max} / 2 )}{{J}_{1}^{2} ( {ϕ}_{max} / 2 ) + {J}_{2}^{2} ( {ϕ}_{max} / 2 )} & ( 6 )\end{matrix}$$

In FIG. 5, it is observed that the nonlinear phase rotation amount φₘₐₓ increases in proportion to the incident power in any of the measured first, third, seventh, and eighth samples.

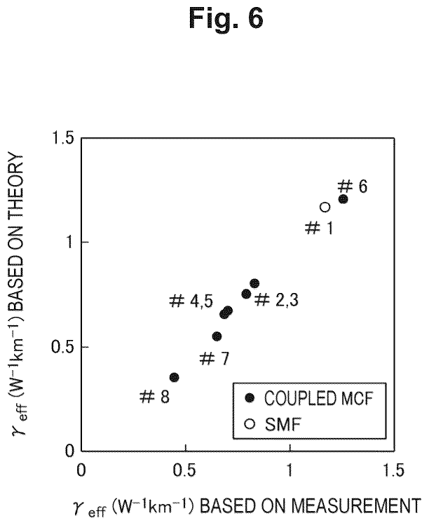

FIG. 6 is a graph illustrating a relationship between the nonlinear coefficient γ_{eff} based on measurement and the nonlinear coefficient γ_{eff} based on theory. FIG. 6 illustrates data for the first to eighth samples illustrated in Table 1. The nonlinear coefficient γ_{eff} based on measurement is obtained by fitting the obtained data with a linear function passing through the origin in the graph illustrating the dependency of the nonlinear phase rotation amount φₘₐₓ on the incident power as illustrated in FIG. 5, and obtaining the nonlinear coefficient γ_{eff} from a slope coefficient a on the basis of Expressions (7) and (8). In Expression (8), α is an attenuation coefficient of the optical fiber 100, and L is a length of the optical fiber 100.

$$\begin{matrix}[ Math . 7 ] & \\ {γ}_{eff} = \frac{a}{2 {L}_{eff}} & ( 7 )\end{matrix}$$

$$\begin{matrix}[ Math . 8 ] & \\ {L}_{eff} = \frac{1 - exp ( α L )}{α} & ( 8 )\end{matrix}$$

The nonlinear coefficient γ_{eff} based on theory is based on Non Patent Literature 7 that discloses a theoretical value of a nonlinear coefficient of a coupled multicore fiber. According to FIG. 6, when the horizontal axis represents the nonlinear coefficient γ_{eff} based on measurement and the vertical axis represents the nonlinear coefficient γ_{eff} based on theory, each piece of data is on a straight line having an inclination of 1 passing through the origin, and it is observed that there is a favorable correlation between the nonlinear coefficient γ_{eff} based on measurement and the nonlinear coefficient γ_{eff} based on theory. Therefore, validity of the nonlinear coefficient γ_{eff} based on measurement according to the first embodiment is confirmed.

As described above, according to the first embodiment, by measuring the spectrum of the optical fiber 100 of the coupled multicore fiber by using the continuous wave light having the wavelength interval Δλ as shown in Expression (1), the nonlinear coefficient γ_{eff} having a favorable correlation with the theoretically obtained nonlinear coefficient γ_{eff} can be obtained. As a result, it is possible to measure a nonlinear coefficient of a coupled multicore fiber, and it is also possible to realize design of an optical fiber communication system using the coupled multicore fiber including a nonlinear reduction.

### Comparative Example

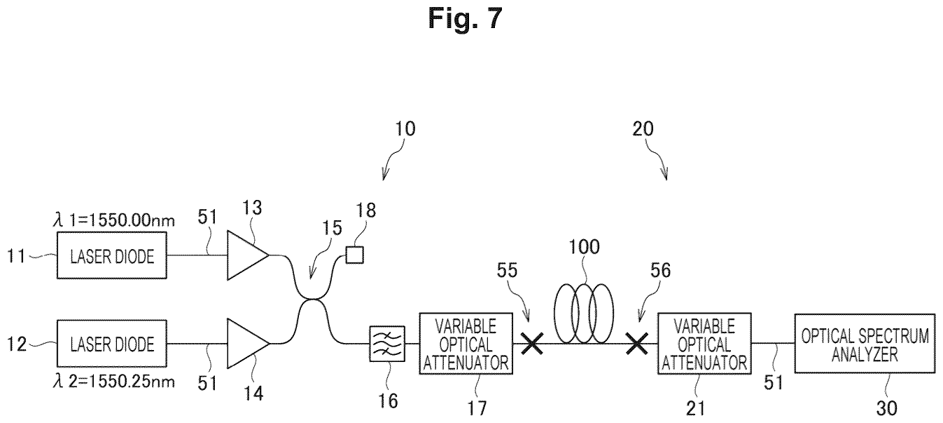

FIG. 7 is a block diagram illustrating a configuration of a measurement device of a comparative example. In the measurement device of the comparative example, constituents common to those of the measurement device of the first embodiment as illustrated in FIG. 1 are denoted by common reference numerals, and a correspondence relationship is illustrated.

A transmission unit 10 of the comparative example includes a first laser diode 11 having a first wavelength λ₁ of 1550 nm and a second laser diode 12 having a second wavelength λ₂ of 1550.28 nm, and both emit continuous wave light. Other configurations of the transmission unit 10 of the comparative example are similar to those of the transmission unit 10 of the measurement device of the first embodiment illustrated in FIG. 1. The optical fiber 100, which is a measurement target in the comparative example, has a length of 500 m.

According to TR62285 of the international standard document, a wavelength difference of the continuous wave light source is about 0.3 nm, and a length of the optical fiber is 500 m. In the comparative example, since the interval Δλ between the first wavelength λ₁ and the second wavelength λ₂ is 0.28 nm and the length of the optical fiber 100 is 500 m, the criterion of the international standard document is satisfied.

Furthermore, according to the international standard document, it is required that an envelope of incident sinusoidal light is not distorted due to a wavelength dispersion or the like, and it is specified to perform setting such that the condition of Expression (9) is satisfied. Here, D is a wavelength dispersion amount (ps/nm/km) of the optical fiber, ω₀ is an average angular frequency of two rays of continuous wave light, Δω is an angular frequency difference, and c is the speed of light in a vacuum.

$$\begin{matrix}[ Math . 9 ] & \\ 2 π c {( \frac{Δω}{{ω}_{0}} )}^{2} {ϕ}_{max} \vert D \vert L ≪ 1 & ( 9 )\end{matrix}$$

The reception unit 20 of the comparative example is different from that of the measurement device of the first embodiment including the high-resolution optical spectrum analyzer 30 in that a normal optical spectrum analyzer 30 is provided. In the comparative example, since the wavelength interval Δλ of 0.38 nm is secured in the continuous wave light emitted from the first laser diode 11 and the second laser diode of the transmission unit 10, it is possible to measure the wavelength interval Δλ even in the normal optical spectrum analyzer 30 that is not a high resolution optical spectrum analyzer.

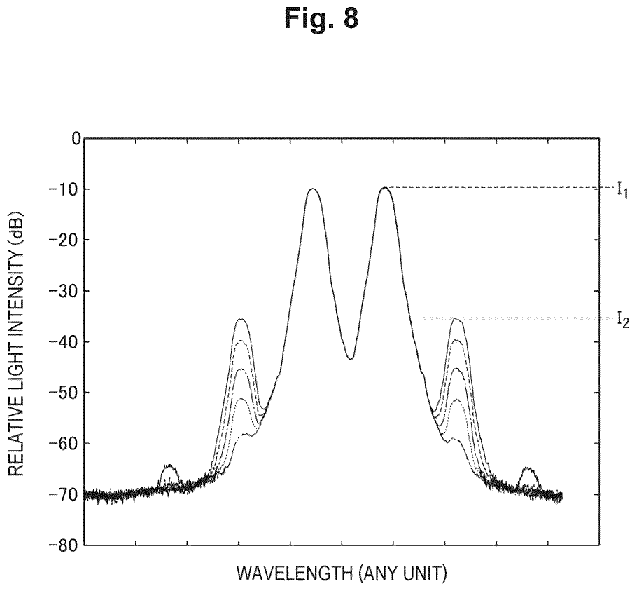

FIG. 8 is a graph illustrating a spectrum of a single-mode fiber measured using the measurement device of the comparative example. In FIG. 8, some illustrated spectra are data obtained when the incident power to the optical fiber 100 is changed, and depending on the incident intensity, sub-peaks due to self-phase modulation that is one of nonlinear phenomena occur on both sides of main peaks due to continuous wave light emitted from the first laser diode 11 and the second laser diode 12 near the center. In this case, the light intensity I₁ of the main peak and the light intensity I₂ of the sub-peak are measured.

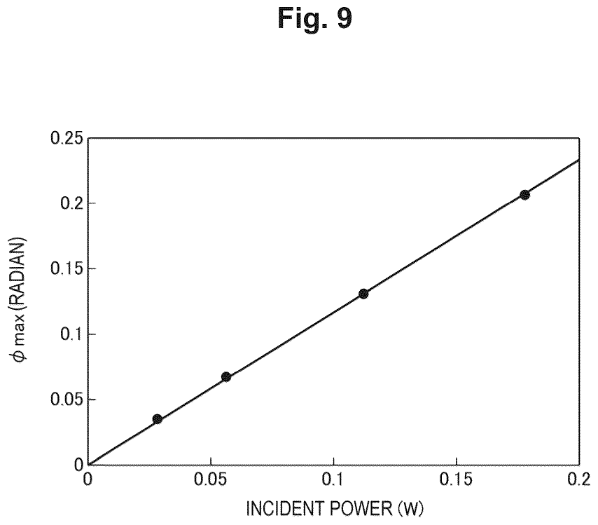

FIG. 9 is a graph illustrating a relationship between the incident power and the nonlinear phase rotation amount φₘₐₓ in the single-mode fiber measured using the measurement device of the comparative example. The nonlinear phase rotation amount φₘₐₓ is obtained from Expression (6) on the basis of the light intensity ratio I₁/I₂ between the light intensity I₁ of the main peak and the light intensity I₂ of the sub-peak of the spectrum obtained in FIG. 8. In the graph of FIG. 9, a proportional relationship is observed between the incident power and the nonlinear phase rotation amount φₘₐₓ. The data of FIG. 9 is fitted with a linear function passing through the origin, and the nonlinear coefficient γ_{eff} is obtained from the slope coefficient a on the basis of Expressions (7) and (8).

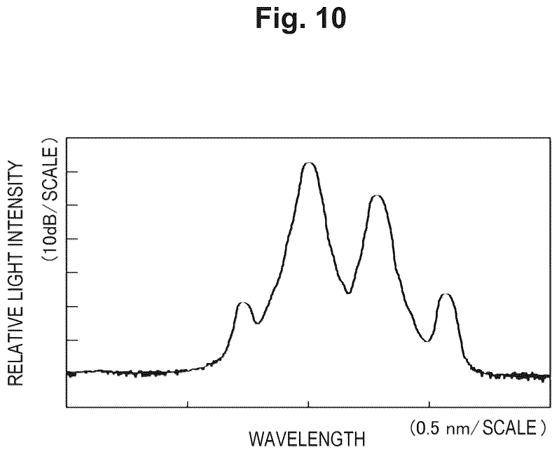

FIG. 10 is a graph illustrating a spectrum of a coupled multicore fiber measured using the measurement device of the comparative example. Unlike the spectrum of the single-mode fiber as illustrated in FIG. 8, it is observed that the symmetry of the spectrum is greatly broken. This is a phenomenon caused by transmission characteristics specific to the coupled multicore fiber.

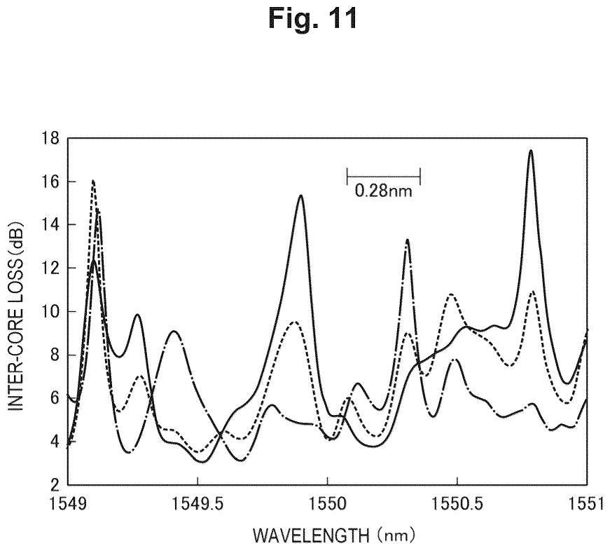

FIG. 11 is a graph obtained by measuring a transmission loss of a coupled multicore fiber. In FIG. 11, the wavelength dependency of the transmission loss when the single-mode fiber was connected such that light was incident on and emitted from one core on the incident side and the emission side was measured by using a two-core coupled multicore fiber. In this example, the measurement was performed by using the same core on the incident and emission sides. However, in the case of the coupled multicore fiber, since light is diffused between the cores as the light propagates through the optical fiber 100, it has been confirmed that a similar result can be obtained even if the single-mode fiber is connected by using a combination of different cores.

The optical fiber 100 was measured in a state of being wound around a bobbin having a radius of 80 mm, and the measurement was performed a plurality of times by replacing the bobbin of the optical fiber without changing the connection state. In any measurement, it can be seen that the transmission characteristics greatly vary with respect to the wavelength. In FIG. 11, a scale of 0.28 nm is shown as a typical wavelength interval Δλ, and it is observed that the variation of the transmission characteristics is large at this wavelength interval Δλ.

The transmission characteristics of such a coupled multicore fiber are also apparent from the measurement results of the spatial mode dispersion coefficient disclosed in Non Patent Literature 5. The characteristic of the coupled multicore fiber is that the spectrum is subjected to inverse Fourier transform and an obtained time waveform is a Gaussian waveform, and its standard deviation is defined as a spatial mode dispersion coefficient. That is, a variation cycle of the spectrum is determined in proportion to the spatial mode dispersion coefficient of the coupled multicore fiber, the variation cycle of the transmission characteristics with respect to the wavelength becomes short when the spatial mode dispersion coefficient is large, and the variation cycle becomes long when the spatial mode dispersion coefficient is small.

In addition, the spatial mode dispersion coefficient is generally about several tens of ps/√km, but since the wavelength dispersion of the optical fiber at 1550 nm is typically 17 ps/nm/km, a differential modal group delay generated in the optical fiber 100 of 500 m at a wavelength shift of the wavelength interval Δλ=0.28 nm is 2.38 ps. If it is assumed that the spatial mode dispersion coefficient is 20 ps/√km in the coupled multicore fiber, the mode dispersion is 14 ps, which is several times larger, at the same length, and thus it is considered that an envelope waveform of the sinusoidal wave propagating through the optical fiber 100 is distorted and the nonlinear coefficient γ cannot be correctly measured.

In contrast, the measurement device of the first embodiment includes a step of setting an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and causing incident light obtained by combining the two rays of continuous wave light to be incident on the optical fiber, a step of measuring a spectrum of propagation light from the optical fiber, and a step of calculating a nonlinear coefficient on the basis of the measured spectrum. Therefore, the nonlinear coefficient of the optical fiber that is a coupled multicore fiber can be measured.

Note that, for example, a general-purpose computer system may be used as the digital signal processor 38 of the reception unit 20 of the measurement device described above. The computer system includes a central processing unit (a CPU or a processor), a memory, a storage (a hard disk drive (HDD) or a solid state drive (SSD)), a communication device, an input device, and an output device. The memory and the storage are storage devices. In this computer system, the function of the digital signal processor 38 is realized by the CPU executing a predetermined program loaded to the memory. The program of the digital signal processor 38 may be stored in a computer-readable recording medium such as an HDD, an SSD, a Universal Serial Bus (USB) memory, a compact disc (CD), or a digital versatile disc (DVD), or may be distributed via a network. The computer-readable recording medium is, for example, a non-transitory recording medium.

Note that the present disclosure is not limited to the first embodiment, and various modifications can be made within the scope of the concept of the present disclosure.

### Second Embodiment

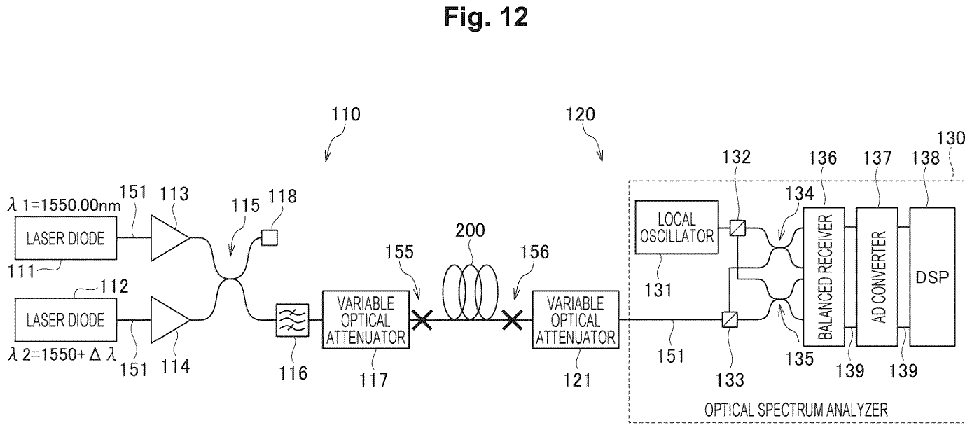

Next, an optical fiber nonlinear coefficient measurement method and device according to a second embodiment will be described. The second embodiment relates to a coupled multicore fiber and a multi-mode fiber. FIG. 12 is a block diagram illustrating a schematic configuration of the measurement device of the second embodiment. As illustrated in FIG. 12, the measurement device includes a transmission unit 110 that transmits light incident on an optical fiber 200 that is a measurement target, and a reception unit 120 that receives propagation light from the optical fiber 200.

The transmission unit 110 includes a first laser diode (LD) 111 that emits a first wavelength λ₁ of 1550 nm of continuous wave (CW) light as a first light source, and a second laser diode 112 that emits a second wavelength λ₂ of 1550+Δλ nm of continuous wave light as a second light source. The transmission unit 110 sets the interval Δλ between the wavelengths λ₁ and λ₂ of the two rays of continuous wave light to be equal to or less than a value calculated by using the average value λ of the wavelengths λ₁ and λ₂ of the two rays of continuous wave light, the length L of the optical fiber 200, which is a measurement target, and the spatial mode dispersion coefficient k of the optical fiber. Specifically, the interval Δλ between the first wavelength λ₁ and the second wavelength λ₂ is defined by Expression (11).

$$\begin{matrix}[ Math . 11 ] & \\ Δλ \leq 0.177 \frac{{λ}^{2}}{ck \sqrt{L}} & ( 11 )\end{matrix}$$

In Expression (11), the wavelength λ is an average value (m) of the first wavelength λ₁ and the second wavelength λ₂, c is the speed of light (m) in a vacuum, k is a spatial mode dispersion coefficient k (s/√km), and L is a length (km) of the optical fiber 200, which is a measurement target.

Here, the spatial mode dispersion coefficient k is defined as a value obtained by performing Fourier transform on the frequency-to-transmission loss spectrum of the optical fiber 200 such that a waveform having an obtained time delay as a horizontal axis is a Gaussian waveform, and dividing a standard deviation thereof by the square root of the length L of the optical fiber 200. Therefore, when a variation cycle Δf of a transmission loss spectrum corresponds to a time delay difference in a case where the length of the optical fiber 200 is L, the variation cycle Δf has a relationship of Expression (12).

$$\begin{matrix}[ Math . 12 ] & \\ Δ f ∝ \frac{1}{k \sqrt{L}} . & ( 12 )\end{matrix}$$

The variation cycle Δf and the wavelength interval Δλ have a relationship of the following Expression (13).

$$\begin{matrix}[ Math . 13 ] & \\ Δ f = \frac{c ( {λ}_{1} - {λ}_{2} )}{{λ}_{1} {λ}_{2}} \approx \frac{c Δλ}{{λ}^{2}} . & ( 13 )\end{matrix}$$

For example, since the spatial mode dispersion coefficient k of the two-core optical fiber 200 having a length of 500 m is 40 ps/√km and the condition of the wavelength interval Δλ is 0.05 nm or less, it is empirically considered that Expression (14) is satisfied by using a correction coefficient A.

$$\begin{matrix}[ Math . 14 ] & \\ \frac{c 0.05 \times {10}^{- 9}}{{λ}^{2}} \leq \frac{A}{40 \times {10}^{- 12} \sqrt{0.5}} & ( 14 )\end{matrix}$$

When the correction coefficient A is calculated from Expression (14), Expression (15) is obtained. Expression (11) is obtained on the basis of Expression (15).

$$\begin{matrix}[ Math . 15 ] & \\ A \geq 0.177 & ( 15 )\end{matrix}$$

In the transmission unit 110, a first optical amplifier 113 and a second optical amplifier 114 are respectively connected to subsequent stages of the first laser diode 111 and the second laser diode 112 via optical paths 151. Each of the first optical amplifier 113 and the second optical amplifier 114 may be a polarization maintaining type (PM) Er-doped optical fiber amplifier (EDFA). An optical coupler 115 is connected to subsequent stages of the first optical amplifier 113 and the second optical amplifier 114, and the optical paths 151 from the first optical amplifier 113 and the second optical amplifier 114 are integrated by the optical coupler 115 and then branched into two optical paths 151 again. The optical coupler 115 may include an optical fiber coupler. One of the optical paths 151 branched from the optical coupler 115 reaches one end of the optical fiber 200 at a first connection portion 155 via a band-pass filter (BPS) 116 and a first variable optical attenuator 117. The other of optical paths 151 branched from optical coupler 115 is connected to an optical terminator 118.

The reception unit 120 includes a second variable optical attenuator 121 and an optical spectrum analyzer 130. The optical spectrum analyzer 130 has a high resolution such that the interval Δλ between the first wavelength λ₁ and the second wavelength λ₂ can be detected. The second variable optical attenuator 121 is connected to the other end of the optical fiber 200 at a second connection portion 156.

The optical spectrum analyzer 130 includes a local oscillator (LO) 131, a first polarization beam splitter (PBS) 132 connected to the local oscillator 131, and a second polarization beam splitter 133 connected to the second variable optical attenuator 121. The polarized light split by the first polarization beam splitter 132 and the second polarization beam splitter (PBS) 133 is incident on a balanced receiver 136 via a second optical coupler 134 and a third optical coupler 135, and is converted into an electrical signal through photoelectric conversion. The signal output from the balanced receiver 136 is subject to analog-to-digital conversion by an AD converter 137, and predetermined computation is performed by a digital signal processor (DSP) 138 such that a nonlinear coefficient of the optical fiber 200 is calculated. The computation in the digital signal processor 138 will be described later. The balanced receiver 136, the AD converter 137, and the digital signal processor 138 are connected via a suitable line 139.

In the second embodiment, a coupled multicore fiber or a multi-mode fiber is assumed as the optical fiber 200 that is a measurement target. However, the present invention is not limited thereto, and may be applied to a single-mode fiber in which each core propagates a single mode. The optical fiber 200 is connected to the optical path 151 at each of the first connection portion 155 of the transmission unit 110 and the second connection portion 156 of the reception unit 120. The connection at the first connection portion 155 and the second connection portion 156 may be performed by using an optical connector, or may be performed by fusing the optical fiber 200 to the optical path 151.

The measurement device of the second embodiment having such a configuration has a feature that the wavelength interval Δλ between the first wavelength λ₁ of the first laser diode 111 and the second wavelength λ₂ of the second laser diode 112 included in the transmission unit 110 is small, for example, 0.1 nm or less. Corresponding to the transmission unit 110, the optical spectrum analyzer 130 included in the reception unit 120 causes propagation light from the optical fiber 200 to interfere with local light oscillated in the local oscillator 131, receives the light in the balanced receiver 136, and then performs signal processing in the electrical domain in the digital signal processor 138 via the AD converter 137, thereby realizing a resolution of 0.1 μm or less.

In the second embodiment, the local oscillator 131 is implemented by individual laser diodes, and a frequency difference or a phase difference between the propagation light and the local light are compensated through signal processing. Light obtained by partially branching the propagation light from the transmission unit 110 may be used as the local light. In this case, a frequency difference can be made substantially 0, so that a signal processing portion can be simplified. As described above, in the second embodiment, the optical spectrum analysis based on the above method is essential, and the configuration is largely different from that of the conventional measurement device.

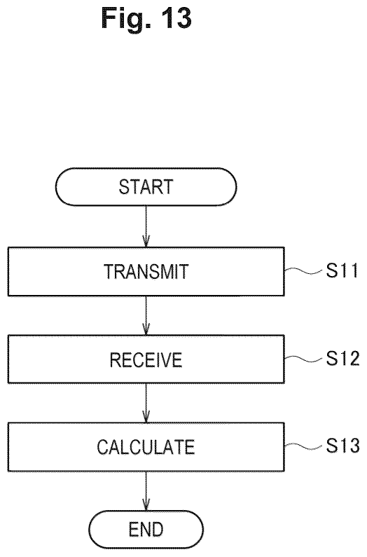

FIG. 13 is a flowchart illustrating a series of steps of the measurement method of the second embodiment. The measurement method of the second embodiment is performed in the measurement device of the second embodiment illustrated in FIG. 12. Hereinafter, a series of steps of the measurement method of the second embodiment will be described in order.

In step S11, light is transmitted from the transmission unit 110 of the measurement device and made incident on the optical fiber 200. In the transmission unit 110, the first laser diode 111 emits continuous wave light having the first wavelength λ₁ of 1550 nm, and the second laser diode 112 of the second light source emits continuous wave light having the second wavelength λ₂ of 1550+Δλ nm. The interval Δλ between the first wavelength λ₁ and the second wavelength λ₂ is defined by Expression (11). The rays of single-wavelength light emitted from the first laser diode 111 and the second laser diode 112 have their optical power amplified by the first optical amplifier 113 and the second optical amplifier 114, and are then combined by the optical coupler 115 with their polarization state aligned, and become sinusoidal light with an envelope oscillating at a frequency corresponding to the wavelength difference. This light passes through the band-pass filter 116 and the first variable optical attenuator 117 and is incident on one end of the optical fiber 200, which is a measurement target. In the first variable optical attenuator 117, the light intensity is adjusted to a desired light intensity.

In step S12, the reception unit 120 of the measurement device receives the propagation light from the optical fiber 200. The propagation light from the optical fiber 200 is adjusted in its light intensity by the second variable optical attenuator 121, then is incident on the optical spectrum analyzer 130, and is split into polarized light by the second polarization beam splitter 133. The light is combined by the second optical coupler 134 and the third optical coupler 135 with the light emitted from the local oscillator 131 and split into the polarized light by the first polarization beam splitter 132, and is then incident on the balanced receiver 136. In the optical spectrum analyzer 130, the local light emitted from the local oscillator 131 interferes with the propagation light from the optical fiber 200 in the second optical coupler 134 and the third optical coupler 135 and is incident on the balanced receiver 136, thereby achieving a high resolution of, for example, a wavelength of 0.1 μm or less. The balanced receiver 136 photoelectrically converts the incident light into an electrical signal by using an appropriate light receiving element, such as a photodiode. The electrical signal obtained through photoelectric conversion in the balanced receiver 136 is subject to analog-to-digital conversion by the AD converter 137 and then sent to the digital signal processor 138.

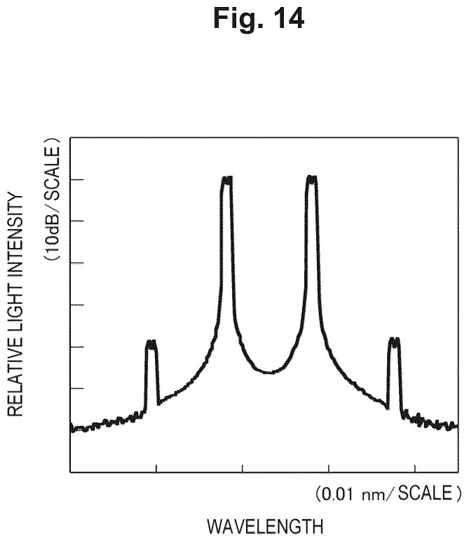

FIG. 14 is a graph illustrating a spectrum of propagation light from the optical fiber 200. As the optical fiber 200, a two-core coupled multicore fiber is used. The wavelength interval Δλ between the first wavelength λ₁ of the first laser diode 111 and the second wavelength λ₂ of the second laser diode 112 is 0.01 nm. The horizontal axis of the graph of FIG. 14 represents a wavelength, and the vertical axis represents a light intensity of the spectrum. In the graph, it is observed that sub-peaks due to self-phase modulation that is one of nonlinear phenomena occur on both sides of main peaks due to continuous wave light emitted from the first laser diode 111 and the second laser diode 112 near the center, depending on the light intensity. Here, the light intensity of the main peak is denoted by I₁, and the light intensity of the sub-peak is denoted by I₂.

In step S13, the digital signal processor 138 of the reception unit 120 of the measurement device performs computation to calculate a nonlinear coefficient of the optical fiber 200. In step S13, the computation is performed on the basis of the propagation light from the optical fiber 200 received in step S12.

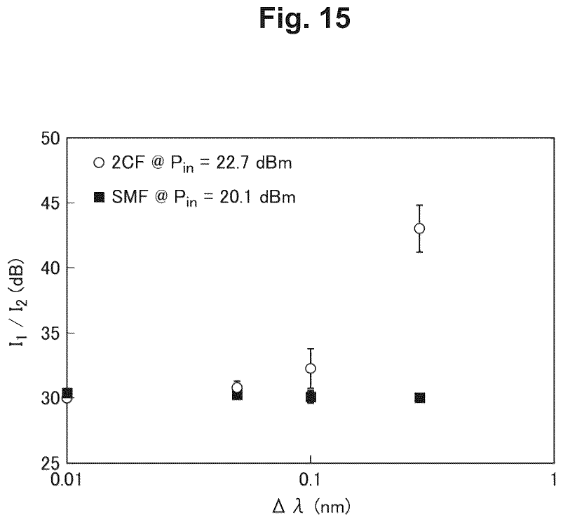

FIG. 15 is a graph illustrating a relationship between the wavelength interval Δλ and the light intensity ratio I₁/I₂. In the graph, data of a two-core coupled multicore fiber is illustrated. The measurement was performed 20 times, and the incident power was 22.7 dBm on average. Error bars indicate the maximum value and the minimum value of data that fluctuate in 20 measurements. FIG. 15 also illustrates measurement results for the single-mode fiber. The single-mode fiber was also measured 20 times, and the incident power was 20.1 dBm on average. Since the dependency of the light intensity ratio I₁/I₂ on the wavelength interval Δλ is derived from the nonlinear characteristics of the optical fiber 200, the result in the single-mode fiber shows a result that there is no dependency on the wavelength interval Δλ. In addition, in the single-mode fiber, it was observed that an amount of variation in 20 measurements was also extremely small.

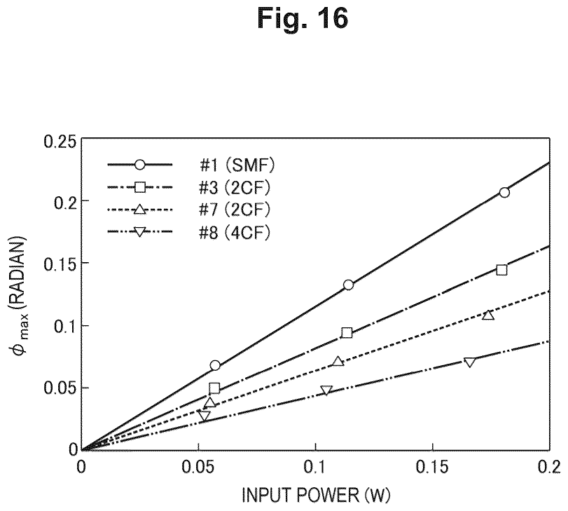

FIG. 16 is a graph illustrating a relationship between the incident power and the nonlinear phase rotation amount φₘₐₓ. Here, among the types of samples illustrated in Table 2, data obtained by measuring the first, third, seventh, and eighth samples as the optical fiber 200, which is a measurement target, is illustrated. The first sample is a single-mode fiber, the third and seventh samples are two-core coupled multicore fibers, and the eighth sample is a four-core coupled multicore fiber.

TABLE 2

| | | | | | SPECIFIC | | |
|---|---|---|---|---|---|---|---|
| | | | | | REFRACTIVE | | |
| | NUMBER | CORE | | CORE | INDEX | SMD | |
| SAMPLE | OF | PITCH | | RADIUS | DIFFERENCE | COEFFICIENT | LENGTH |
| NUMBER # | CORES | (μm) | DOPANT | (μm) | (%) | (ps/√km) | (m) |
| 1 | 1 | NA | GeO₂ | 4.2 | 0.34 | NA | 500 |
| | | | CORE | | | | |
| 2 | 2 | 20 | GeO₂ | 4.5 | 0.44 | 30 | 500 |
| | | | CORE | | | | |
| 3 | 2 | 25 | GeO₂ | 4.5 | 0.4 | 62 | 500 |
| | | | CORE | | | | |
| 4 | 2 | 20 | F CLAD | 4.5 | 0.38 | 45 | 500 |
| 5 | 2 | 25 | F CLAD | 4.4 | 0.35 | 43 | 500 |
| 6 | 2 | 21 | F CLAD | 3.3 | 0.67 | 24 | 500 |
| 7 | 2 | 21 | F CLAD | 4.8 | 0.3 | 60 | 500 |
| 8 | 4 | 18 | F CLAD | 4.2 | 0.33 | 22 | 500 |
| 9 | 4 | 18 | F CLAD | 3.8 | 0.35 | 48 | 500 |
| 10 | 12 | 16.4 | GeO₂ | 4.8 | 0.35 | 8.4 | 1000 |
| | | | CORE | | | | |

The nonlinear phase rotation amount φₘₐₓ was obtained from Expression (16) on the basis of the light intensity ratio I₁/I₂ for the light intensity I₁ of the main peak and the light intensity I₂ of the sub-peak in the spectrum of the propagation light from the optical fiber 200 as illustrated in FIG. 14. Here, Jx (where x=0, 1, and 2) is a first-type x-order Bessel function.

$$\begin{matrix}[ Math . 16 ] & \\ \frac{{I}_{1}}{{I}_{2}} = \frac{{J}_{0}^{2} ( {ϕ}_{max} / 2 ) + {J}_{1}^{2} ( {ϕ}_{max} / 2 )}{{J}_{1}^{2} ( {ϕ}_{max} / 2 ) + {J}_{2}^{2} ( {ϕ}_{max} / 2 )} & ( 16 )\end{matrix}$$

In FIG. 16, it is observed that the nonlinear phase rotation amount φₘₐₓ increases in proportion to the incident power in any of the measured first, third, seventh, and eighth samples.

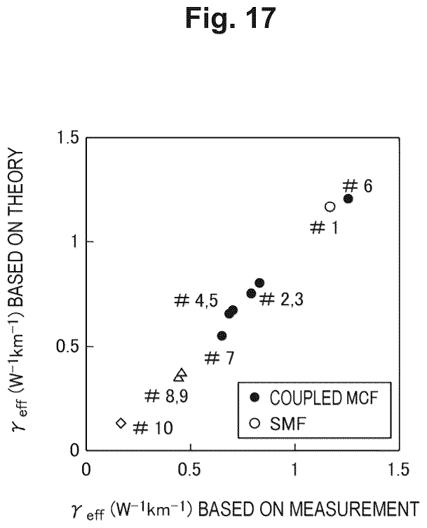

FIG. 17 is a graph illustrating a relationship between the nonlinear coefficient γ_{eff} based on measurement and the nonlinear coefficient γ_{eff} based on theory. FIG. 17 illustrates data for the first to tenth samples illustrated in Table 2. The nonlinear coefficient γ_{eff} based on measurement is obtained by fitting the obtained data with a linear function passing through the origin in the graph illustrating the dependency of the nonlinear phase rotation amount φₘₐₓ on the incident power as illustrated in FIG. 16, and obtaining the nonlinear coefficient γ_{eff} from a slope coefficient a on the basis of Expressions (17) and (18). In Expression (18), α is an attenuation coefficient of the optical fiber 200, and L is a length of the optical fiber 200.

$$\begin{matrix}[ Math . 17 ] & \\ {γ}_{eff} = \frac{a}{2 {L}_{eff}} & ( 17 )\end{matrix}$$

$$\begin{matrix}[ Math . 18 ] & \\ {L}_{eff} = \frac{1 - exp ( - α L )}{α} & ( 18 )\end{matrix}$$

The nonlinear coefficient γ_{eff} based on theory is based on Non Patent Literature 7 that discloses a theoretical value of a nonlinear coefficient of a coupled multicore fiber. According to FIG. 17, when the horizontal axis represents the nonlinear coefficient γ_{eff} based on measurement and the vertical axis represents the nonlinear coefficient γ_{eff} based on theory, each piece of data is on a straight line having an inclination of 1 passing through the origin, and it is observed that there is a favorable correlation between the nonlinear coefficient γ_{eff} based on measurement and the nonlinear coefficient γ_{eff} based on theory. Therefore, validity of the nonlinear coefficient γ_{eff} based on measurement according to the second embodiment is confirmed.

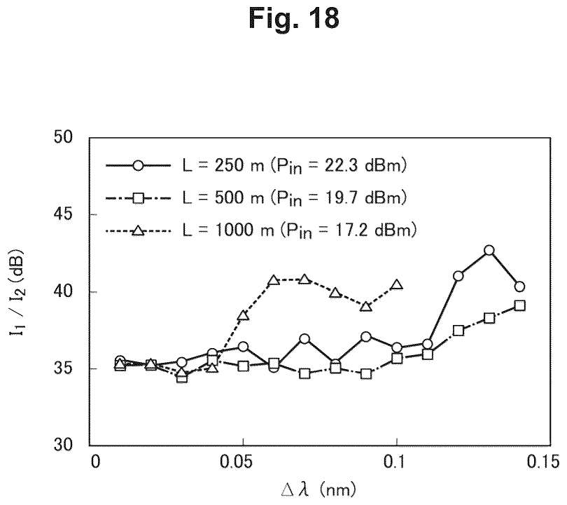

FIG. 18 is a graph illustrating a relationship between the wavelength interval Δλ and the light intensity ratio I₁/I₂ for fourth samples having different lengths. Since the wavelength interval Δλ is considered to be related to a total mode dispersion amount of the coupled multicore fiber as shown in Expression (11), the dependency of the light intensity ratio I₁/I₂ on the wavelength interval Δλ was measured by changing the length of the optical fiber 200 of the fourth samples. Here, the total mode dispersion amount is a value obtained by multiplying the spatial mode dispersion coefficient (ps/√km) described above by the fiber length. The input power to the optical fiber 200 is adjusted such that a value of the light intensity ratio I₁/I₂ is the same for each optical fiber having a different length. As can be seen from FIG. 18, when the length of the optical fiber 200 of the fourth samples is changed, the condition of the wavelength interval Δλ at which a measurement error occurs is changed.

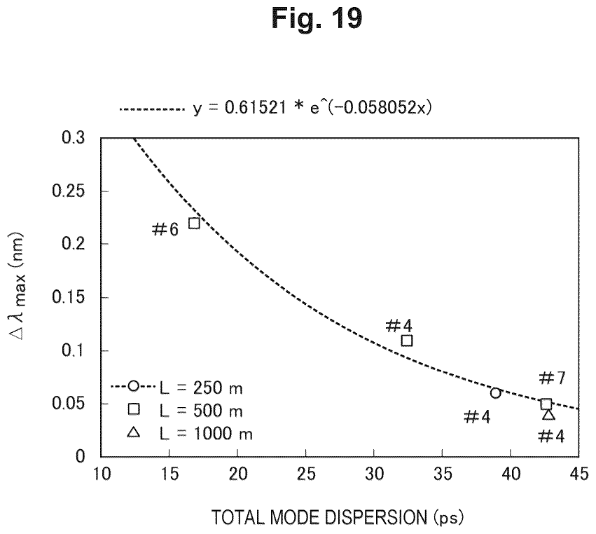

FIG. 19 is a graph illustrating a relationship between the total mode dispersion amount and the maximum wavelength interval Δλmax. The maximum wavelength interval Δλmax was set to a minimum wavelength interval Δλ at which a measurement error of 1 dB is generated with a value of the light intensity ratio I₁/I₂ at the wavelength interval Δλ of 0.01 nm as a reference. The relationship between the total mode dispersion amount and the maximum wavelength interval Δλmax was checked for different samples.

Even if the length or the type of the optical fiber 200 is changed, when the wavelength interval Δλ and the total mode dispersion amount D satisfy Expression (19), a measurement error within 1 dB is secured in the value of the light intensity ratio I₁/I₂ with respect to the wavelength interval Δλ.

$$\begin{matrix}[ Math . 19 ] & \\ Δλ < 0.61521 \times {e}^{( - 0.058052 \times D )} & ( 19 )\end{matrix}$$

The units of the total mode dispersion amount D and the maximum wavelength interval Δλmax are picoseconds and nanometers, respectively. Note that D=σL in a case where the mode dispersion coefficient is proportional to the distance as in the multi-mode fiber, and D=σ√L in a case where the mode dispersion coefficient is proportional to the square root of the distance as in the coupled multicore fiber.

As can be seen from FIG. 19, when the total mode dispersion amount is 13 ps or less, the measurement can be performed even when Δλ=0.28 nm, which is a set value of a conventional method described in a comparative example that will be described later. However, in order to obtain such a total mode dispersion amount, it is considered that the length of the optical fiber 200 is shorter than 500 m, but if the length of the optical fiber 200 is short, input power for generating nonlinear phase rotation increases, which is not preferable. In any case, the second embodiment can be said to be an effective method in a region where the total mode dispersion is 13 ps or more. In addition, when Δλ=0.01 nm is set according to Expression (19), the total mode dispersion up to 70 ps can be supported.

Considering the wavelength stability of a general laser, it is considered difficult to greatly reduce the wavelength from Δλ=0.01 nm, so that the total mode dispersion amount to which the second embodiment can be applied can be said to be 13 to 70 ps. However, this is not applied in a case where the laser technology is improved and the wavelength stability is improved.

As described above, according to the second embodiment, by measuring the spectrum of the optical fiber 200 that is the coupled multicore fiber by using the continuous wave light having the wavelength interval Δλ as shown in Expression (11), the nonlinear coefficient γ_{eff} having a favorable correlation with the theoretically obtained nonlinear coefficient γ_{eff} can be obtained. As a result, it is possible to measure a nonlinear coefficient of a coupled multicore fiber, and it is also possible to realize design of an optical fiber communication system using the coupled multicore fiber including a nonlinear reduction. The same applies to a multi-mode fiber.

Further, according to the second embodiment, by satisfying the relational expression of Expression (19), an error of the light intensity ratio I₁/I₂ with respect to the wavelength difference Δλ can be controlled to 1 dB or less. Therefore, it is possible to measure the nonlinear coefficient γ_{eff} based on the light intensity ratio I₁/I₂.

### Comparative Example

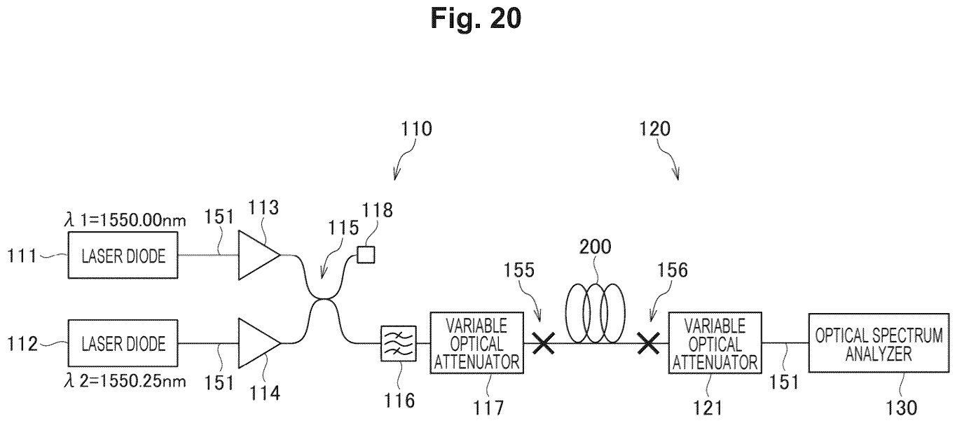

FIG. 20 is a block diagram illustrating a configuration of a measurement device of a comparative example. In the measurement device of the comparative example, constituents common to those of the measurement device of the second embodiment as illustrated in FIG. 12 are denoted by common reference numerals, and a correspondence relationship is illustrated.

A transmission unit 110 of the comparative example includes a first laser diode 111 having a first wavelength λ₁ of 1550 nm and a second laser diode 112 having a second wavelength λ₂ of 1550.28 nm, and both emit continuous wave light. Other configurations of the transmission unit 110 of the comparative example are similar to those of the transmission unit 110 of the measurement device of the second embodiment illustrated in FIG. 12. The optical fiber 200, which is a measurement target in the comparative example, has a length of 500 m.

According to TR62285 of the international standard document, a wavelength difference of the continuous wave light source is about 0.3 nm, and a length of the optical fiber is 500 m. In the comparative example, since the interval Δλ between the first wavelength λ₁ and the second wavelength λ₂ is 0.28 nm and the length of the optical fiber 200 is 500 m, the criterion of the international standard document is satisfied.

Furthermore, according to the international standard document, it is required that an envelope of incident sinusoidal light is not distorted due to a wavelength dispersion or the like, and it is specified to perform setting such that the condition of Expression (20) is satisfied. Here, D is a wavelength dispersion amount (ps/nm/km) of the optical fiber 200, ω₀ is an average angular frequency of two rays of continuous wave light, Δω is an angular frequency difference, and c is the speed of light in a vacuum.

$$\begin{matrix}[ Math . 20 ] & \\ 2 π c {( \frac{Δω}{{ω}_{0}} )}^{2} {ϕ}_{max} \vert D \vert L ≪ 1 & ( 20 )\end{matrix}$$

The reception unit 120 of the comparative example is different from that of the measurement device of the second embodiment including the high-resolution optical spectrum analyzer 130 in that a normal optical spectrum analyzer 130 is provided. In the comparative example, since the wavelength interval Δλ of 0.38 nm is secured in the continuous wave light emitted from the first laser diode 111 and the second laser diode of the transmission unit 110, it is possible to measure the wavelength interval Δλ even in the normal optical spectrum analyzer 130 that is not a high resolution optical spectrum analyzer.

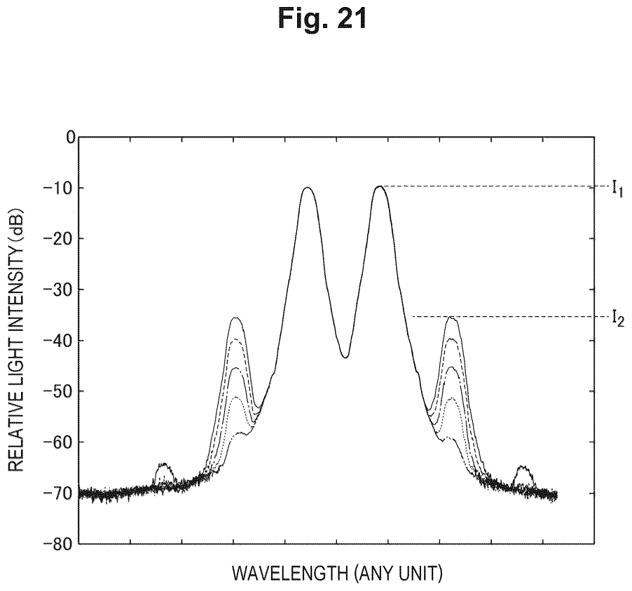

FIG. 21 is a graph illustrating a spectrum of a single-mode fiber measured using the measurement device of the comparative example. In FIG. 19, some illustrated spectra are data obtained when the incident power to the optical fiber 200 is changed, and depending on the incident intensity, sub-peaks due to self-phase modulation that is one of nonlinear phenomena occur on both sides of main peaks due to continuous wave light emitted from the first laser diode 111 and the second laser diode 112 near the center. In this case, the light intensity I₁ of the main peak and the light intensity I₂ of the sub-peak are measured.

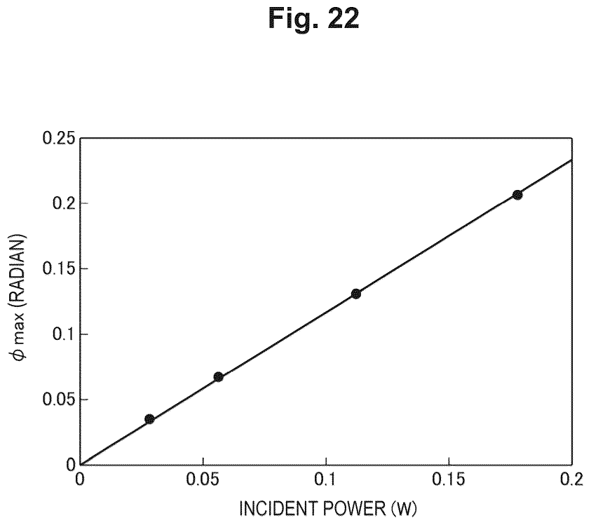

FIG. 22 is a graph illustrating a relationship between the incident power and the nonlinear phase rotation amount φₘₐₓ in the single-mode fiber measured using the measurement device of the comparative example. The nonlinear phase rotation amount φₘₐₓ is obtained from Expression (16) on the basis of the light intensity ratio I₁/I₂ between the light intensity I₁ of the main peak and the light intensity I₂ of the sub-peak of the spectrum obtained in FIG. 21. In the graph of FIG. 22, a proportional relationship is observed between the incident power and the nonlinear phase rotation amount φₘₐₓ. The data of FIG. 22 is fitted with a linear function passing through the origin, and the nonlinear coefficient γ_{eff} is obtained from the slope coefficient a on the basis of Expressions (17) and (18).

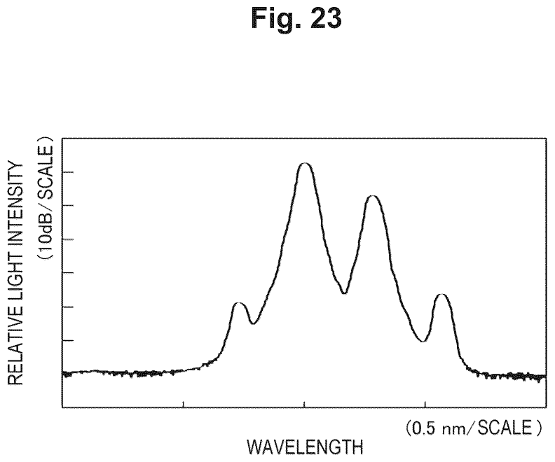

FIG. 23 is a graph illustrating a spectrum of a coupled multicore fiber measured using the measurement device of the comparative example. Unlike the spectrum of the single-mode fiber as illustrated in FIG. 21, it is observed that the symmetry of the spectrum is greatly broken. This is a phenomenon caused by transmission characteristics specific to the coupled multicore fiber.

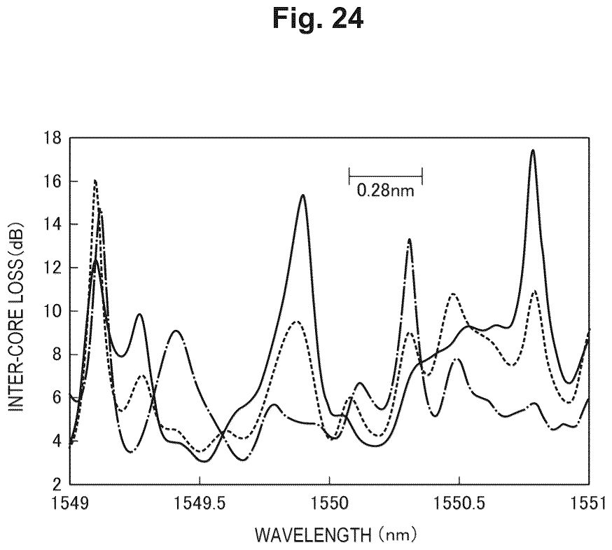

FIG. 24 is a graph obtained by measuring a transmission loss of a coupled multicore fiber. In FIG. 24, the wavelength dependency of the transmission loss when the single-mode fiber was connected such that light was incident on and emitted from one core on the incident side and the emission side was measured by using a two-core coupled multicore fiber. In this example, the measurement was performed by using the same core on the incident and emission sides. However, in the case of the coupled multicore fiber, since light is diffused between the cores as the light propagates through the optical fiber 200, it has been confirmed that a similar result can be obtained even if the single-mode fiber is connected by using a combination of different cores.

The optical fiber 200 was measured in a state of being wound around a bobbin having a radius of 80 mm, and the measurement was performed a plurality of times by replacing the bobbin of the optical fiber without changing the connection state. In any measurement, it can be seen that the transmission characteristics greatly vary with respect to the wavelength. In FIG. 24, a scale of 0.28 nm is shown as a typical wavelength interval Δλ, and it is observed that the variation of the transmission characteristics is large at this wavelength interval Δλ.

The transmission characteristics of such a coupled multicore fiber are also apparent from the measurement results of the spatial mode dispersion coefficient disclosed in Non Patent Literature 5. The characteristic of the coupled multicore fiber is that the spectrum is subjected to inverse Fourier transform and an obtained time waveform is a Gaussian waveform, and its standard deviation is defined as a spatial mode dispersion coefficient. That is, a variation cycle of the spectrum is determined in proportion to the spatial mode dispersion coefficient of the coupled multicore fiber, the variation cycle of the transmission characteristics with respect to the wavelength becomes short when the spatial mode dispersion coefficient is large, and the variation cycle becomes long when the spatial mode dispersion coefficient is small. It is known that a plurality of modes generated at input and output connection points interfere with each other to obtain transmission characteristics having similar wavelength dependency similarly in a multi-mode fiber.

In addition, the spatial mode dispersion coefficient is generally about several tens of ps/√km, but since the wavelength dispersion of the optical fiber at 1550 nm is typically 17 ps/nm/km, a differential modal group delay generated in the optical fiber 100 of 500 m at a wavelength shift of the wavelength interval Δλ=0.28 nm is 2.38 ps. If it is assumed that the spatial mode dispersion coefficient is 20 ps/√km in the coupled multicore fiber, the mode dispersion is 14 ps, which is several times larger, at the same length, and thus it is considered that an envelope waveform of the sinusoidal wave propagating through the optical fiber 100 is distorted and the nonlinear coefficient γ cannot be correctly measured.

Also in the multi-mode fiber, it is known that a mode dispersion value is about several tens of ps/km as disclosed in Non Patent Literature 2, and it can be seen that the mode dispersion value is a factor that distorts a waveform more than the wavelength dispersion in a similar manner to the coupled multicore fiber.

In contrast, the measurement device of the second embodiment includes a step of setting an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and causing incident light obtained by combining the two rays of continuous wave light to be incident on the optical fiber, a step of measuring a spectrum of propagation light from the optical fiber, and a step of calculating a nonlinear coefficient on the basis of the measured spectrum. Therefore, the nonlinear coefficient of the optical fiber that is a coupled multicore fiber can be measured.

Note that, for example, a general-purpose computer system may be used as the digital signal processor 138 of the reception unit 120 of the measurement device described above. The computer system includes a central processing unit (a CPU or a processor), a memory, a storage (a hard disk drive (HDD) or a solid state drive (SSD)), a communication device, an input device, and an output device. The memory and the storage are storage devices. In this computer system, the function of the digital signal processor 38 is realized by the CPU executing a predetermined program loaded to the memory. The program of the digital signal processor 138 may be stored in a computer-readable recording medium such as an HDD, an SSD, a Universal Serial Bus (USB) memory, a compact disc (CD), or a digital versatile disc (DVD), or may be distributed via a network. The computer-readable recording medium is, for example, a non-transitory recording medium.

Note that the present disclosure is not limited to the second embodiment, and various modifications can be made within the scope of the concept of the present disclosure.

### REFERENCE SIGNS LIST

10 Transmission unit
11 First laser diode
12 Second laser diode
30 Optical spectrum analyzer
31 Local oscillator
36 Balanced receiver
37 AD converter
38 Digital signal processor
100 Optical fiber
110 Transmission unit
111 First laser diode
112 Second laser diode
130 Optical spectrum analyzer
131 Local oscillator
136 Balanced receiver
137 AD converter
138 Digital signal processor
200 Optical fiber

1. An optical fiber nonlinear coefficient measurement method for a coupled multicore fiber or a multi-mode fiber, the optical fiber nonlinear coefficient measurement method comprising:
setting an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and causing incident light obtained by combining the two rays of continuous wave light to be incident on the optical fiber;
measuring a spectrum of propagation light from the optical fiber; and
calculating a nonlinear coefficient on the basis of the measured spectrum.

2. The optical fiber nonlinear coefficient measurement method according to claim 1, wherein the interval Δλ (m) between the wavelengths of the two rays of continuous wave light is given by a following expression:
$$Δλ \leq 0.177 \frac{{λ}^{2}}{ck \sqrt{L}}$$
where λ (m) is the average value of the wavelengths of the two rays of continuous wave light, L (km) is the length of the optical fiber, k (s/√km) is the spatial mode dispersion coefficient, and c (m/s) is a speed of light in a vacuum.

3. The optical fiber nonlinear coefficient measurement method according to claim 1, wherein the interval Δλ (nm) between the wavelengths of the two rays of continuous wave light is given by a following expression:
$$Δλ < 0.61521 \times {e}^{( - 0.058052 \times D )}$$
where D (ps) is a total mode dispersion amount.

4. The optical fiber nonlinear coefficient measurement method according to claim 1, wherein in the calculating the nonlinear coefficient, a phase shift amount is obtained based on a ratio between light intensities of peaks caused by the two pieces of continuous wave light and light intensities of peaks caused by a nonlinear optical effect generated in the optical fiber, and the nonlinear coefficient of the optical fiber is calculated on the basis of a relationship between the phase shift amount and incident power.

5. An optical fiber nonlinear coefficient measurement device for a coupled multicore fiber or a multi-mode fiber, the optical fiber nonlinear coefficient measurement device comprising:
a transmitter that:
includes two light sources each configured to emit a ray of continuous wave light, and an optical coupler configured to combine two rays of continuous wave light supplied from the two light sources; and
configured to set an interval between wavelengths of two rays of continuous wave light to be equal to or less than a value calculated by using an average value of the wavelengths of the two rays of continuous wave light, a length of an optical fiber that is a measurement target, and a spatial mode dispersion coefficient of the optical fiber, and cause incident light obtained by combining the two rays of continuous wave light to be incident on the optical fiber; and
a receiver that includes an optical spectrum analyzer: having a resolution at which an interval between the wavelengths is able to be detected; and configured to measure a spectrum of propagation light from the optical fiber.

6. The optical fiber nonlinear coefficient measurement device according to claim 5, wherein the interval Δλ (m) between the wavelengths of the two rays of continuous wave light is given by a following expression:
$$Δλ \leq 0.177 \frac{{λ}^{2}}{ck \sqrt{L}}$$
where λ (m) is the average value of the wavelengths of the two rays of continuous wave light, L (km) is the length of the optical fiber, k (s/√km) is the spatial mode dispersion coefficient, and c (m/s) is a speed of light c (m/s) in a vacuum.

7. The optical fiber nonlinear coefficient measurement device according to claim 5, wherein the interval Δλ (nm) between the wavelengths of the two rays of continuous wave light is given by a following expression:
$$Δλ < 0.61521 \times {e}^{( - 0.058052 \times D )}$$
where D (ps) is a total mode dispersion amount.

8. The optical fiber nonlinear coefficient measurement device according to claim 5, wherein the optical spectrum analyzer includes a computing circuit configured to obtain a phase shift amount on the basis of a ratio between light intensities of peaks caused by the two pieces of continuous wave light and light intensities of peaks caused by a nonlinear optical effect generated in the optical fiber, and to calculate the nonlinear coefficient of the optical fiber on the basis of a relationship between the phase shift amount and incident power.
